(19) United States
(12) Patent Application Publication
(10) Pub. No.: US 2024/0421598 A1
(43) Pub. Date: Dec. 19, 2024

(54) CELLULAR NETWORK HAVING ENERGY LOAD SHIFTING AND ALTERNATIVE ENERGY SOURCES

(71) Applicant: TalkingHeads Wireless, Inc., Roslindale, MA (US)

(72) Inventors: John E. DeRoo, Atlanta, GA (US); William Sanchez, Roslindale, MA (US); Joel L. Dawson, Roslindale, MA (US)

(73) Assignee: TalkingHeads Wireless, Inc., Roslindale, MA (US)

(21) Appl. No.: 18/743,328

(22) Filed: Jun. 14, 2024

Related U.S. Application Data
(60) Provisional application No. 63/508,547, filed on Jun. 16, 2023.

(51) Int. Cl. H02J 3/00; H02J 3/38

(52) U.S. Cl. CPC H02J 3/0075; H02J 3/38; H02J 2300/24; H02J 2300/28

(57) ABSTRACT

Methods and apparatus for a cellular network system that includes an energy controller having a processor and memory configured to: provision a battery backup to supply power to the system for X number of hours, process information for at least one alternative energy source, and load shift power to the system between mains power and the battery backup based on one or more characteristics of the mains power, the battery backup, and/or the at least one alternative energy source.

### CROSS REFERENCE TO RELATED APPLICATIONS

The present application claims the benefit of U.S. Provisional Application No. 63/508,547, filed on Jun. 16, 2023, which is incorporated herein by reference.

### BACKGROUND

As is known in the art, mobile communication networks (e.g., cellular networks) have become more sophisticated and powerful which has led to a corresponding increase in the power consumption of mobile communication networks. With such an increase in power consumption, the amount of energy needed from the electrical grid to operate communication networks has also increased. In addition to an increase in the amount of energy required by mobile communication networks, the cost of energy has increased significantly.

### SUMMARY

Example embodiments of the disclosure provide methods and apparatus for mobile communication networks that include load-shifting of energy between mains and battery backup. Cellular sites typically have battery backups that can maintain site operation for some number of hours in the event of a power disruption. In some embodiments, battery backups can be used for load-shifting based on one or more characteristics of mains power. In some embodiments, mains or battery power is selected based on time-of-use billing plans, which may have different rates for on and off peak power, offered by electric power companies. In some embodiments, battery backup is used during times of peak electric rates and mains is used during times of off peak electric rates.

As used herein, mains refers to energy in an electrical grid transmitted over power lines from a station or substation that is down-converted in voltage to a local customer.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like names designate corresponding parts throughout the different views. Furthermore, embodiments are illustrated by way of example and not limitation in the figures, in which:

FIG. 1 is a block diagram of a cellular network having power load sharing between mains and battery backup;

FIG. 2 is a block diagram showing further detail of a cellular network having power load sharing between mains and battery backup;

FIG. 3 is a tabular representation of an example on-peak/off-peak rate schedule for various state power providers;

FIG. 4 is a flow diagram of a process for power load sharing between mains and battery backup in a cellular network system;

FIG. 5 is a flow diagram of a process for power load sharing between mains and battery backup in a cellular network system;

FIG. 6 is a block diagram of a cellular network having power load sharing between mains and battery backup with alternative energy sources;

FIG. 7 is a flow diagram of a process for power load sharing between mains and battery backup in a cellular network system including processing information from at least one alternative energy source; and

FIG. 8 is schematic representation of an example computer than can perform at least a portion of the processing described herein.

### DETAILED DESCRIPTION

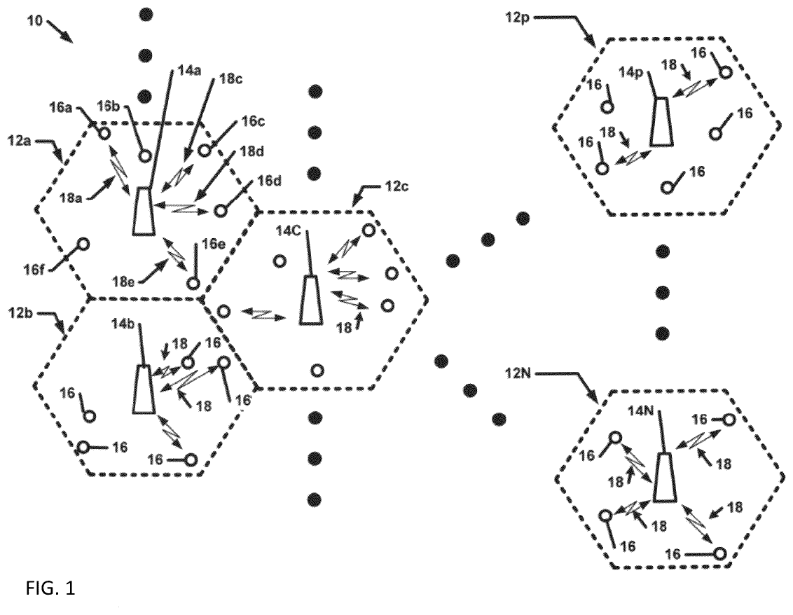

FIG. 1 shows an example cellular network 10 having power load shifting based on one or more energy characteristics in accordance with example embodiments of the disclosure. The illustrated network 10 comprises a plurality of cells 12a-12N. In this illustrative embodiment, cellular network 10 is illustrated as a Global System for Mobile (GSM) cellular network in which base stations are deployed to establish cells having substantially uniform hexagonal shapes. In this illustrative embodiment, cells 12a-12N comprise at least one distributed base station 14a-14N. As used herein, the phrase “distributed base station” comprises one or more baseband units and one or more remote radio heads (RRHs). The RRHs are typically coupled to a cell tower as is generally known. Such RRHs may be located substantially at or near the center of each cell and be coupled to one or more antennas. In embodiments, the one or more antennas may be integrated with RRH circuitry to provide an integrated antenna/RRH. Thus, a so-called integrated RRH may comprise RRH circuitry and one or more antennas.

Taking cell 12a as representative of cells 12b-12N, cell 12a comprises distributed base station 14a. Distributed base station 14a comprises a baseband unit coupled to one or more RRHs (which may be integrated RRHs).

At certain points in time, one or more mobile units generally denoted 16 are positioned in various ones of cells 12a-12N. In the example of FIG. 1, mobile units 16a-16f may be positioned within cell 14a at certain points in time or for periods of time. While within cell 14a, one, some or all of the mobile units 16a-16f may establish a wireless communication link (or more simply, a link generally denoted 18) with distributed base station 14a. In the example of FIG. 1, mobile units 16a and 16c-16e establish corresponding links 18a and 18c-18e with distributed base station 34a (e.g., unit via an RRH) while mobile units 16b, 16f do not establish links with distributed base station 14a. Each link 18a and 18c-18e has an associated signal to noise ratio (SNR).

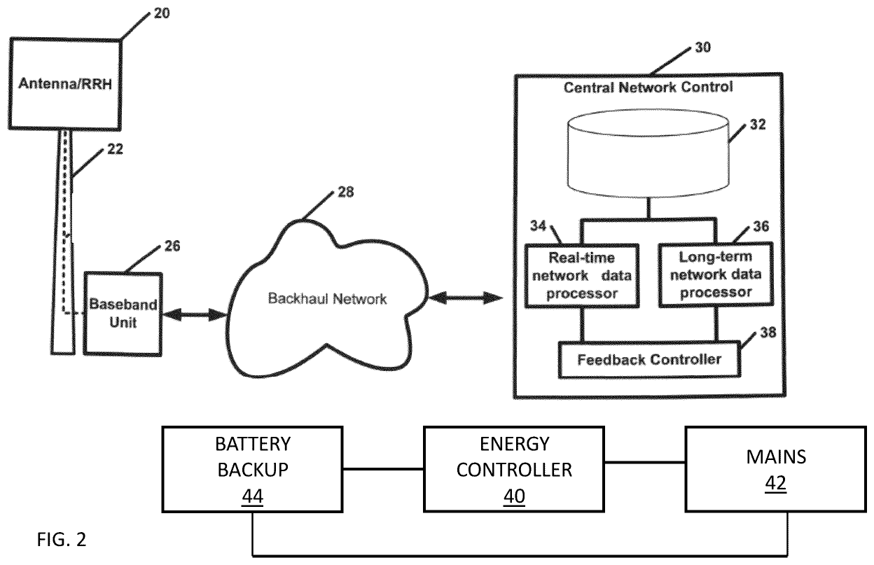

FIG. 2 shows further detail of an example cellular system including load shifting with an antenna and RRH 20 deployed or otherwise disposed on a cell tower coupled to a baseband unit 26. RRH 20 may be coupled to baseband unit 26 using wireless techniques (e.g., microwave, millimeter wave (MMW), free space optics (FSO) links or using hard wired techniques (e.g., fiber optic cable).

In some embodiments, the antenna and RRH may be provided as separate components which are coupled together via a mechanical connection such as via a coaxial cable with a first end having an RF connector coupled to an antenna port and a second end having an RF connector coupled to an output port of an RRH transmit signal path comprising a (power amplifier (PA) to thus provide an RF signal path between an output of the PA and an input of the antenna. In other embodiments, the antenna and the RRH may be provided as an integrated unit (i.e., an integrated RRH/antenna unit) in which case a coaxial cable connection between the antenna and the RRH circuitry may not be required. In some embodiments, a connection between the antenna and the RRH is bidirectional and carries both transmit and receive signals.

The baseband unit 26 is coupled through a network 28 (a so-called backhaul network) to a central network control 30 (e.g., a so-called central office). Network characteristics (including link and/or channel characteristics) which may be measured, collected or otherwise determined as well as information related or derived from network characteristics may be provided to one or more databases 32 (with a single database being illustrated in FIG. 2) and/or one or more processors 34, 36 from the baseband unit 26. Such information may, for example, include but is not limited to measured SNR or the maximum realizable capacity for a channel. This information may be collected on individual links, on individual cells, or on the network as a whole.

In the illustrated embodiment, the cellular system includes an energy controller 40 coupled to mains 42 and battery backup 44. In general, mains 42 is used to recharge the battery backup 44. The energy controller 40 selects which of the mains 42 or battery backup 44 to power the components of the cellular system. In embodiments, the energy controller 40 uses one or more characteristics of energy from the mains 42 and/or battery backup 44 for selecting the energy source for the system, as described more fully below.

In general, the battery backup 44 is sized to maintain operation of the cellular network in the event of a power failure. The size of the batteries in the battery backup 44 depends on the amount of power the equipment consumes and the length of time it needs to operate without mains power 42. It will be readily appreciated that as 5G is added to cell sites, energy consumption generally increases, and the sizing of the batteries at the cell sites may need to be adjusted.

In one example embodiment, an example characteristic on which to base energy load sharing includes the cost of energy from the grid, i.e., mains. Power companies have Residential, Commercial, & Industrial time-of-use (TOU) plans in which customers are incentivized via lower rates to defer power usage to off-peak times. Relatively simple rate plans use a set schedule based on historical data. Some rate plans incorporate short-term predictable transient effects, such as weather.

In one detailed example, Georgia Power currently has a commercial TOU plan with published rates and schedule, along with several non-TOU plans. On the days when this applies, there are five hours of peak in the afternoon and early evening, and nineteen hours of off-peak each day, with an over 2× difference in the energy price between peak and off-peak pricing. The price of the off-peak power in the TOU plan is slightly less than the price of the non-TOU plan. Example energy charges are set forth below:

Energy Charges:

| | |
|---|---|
| June through September: | |
| On-Peak kWh | 16.9230¢ per kWh |
| Off-Peak kWh | 7.9811¢ per kWh |
| October through May: | |
| First 1500 kWh | 7.9811¢ per kWh |
| Over 1500 kWh | 3.0518¢ per kWh |

In embodiments, an energy controller for the system analyzes energy costs based on mains peak and off-peak rates and determines when to select battery backup for the system and when to select mains. For example, if all of the power that is consumed during the peak hours can be supplied by batteries that are recharged during off-peak, in one particular example the cost savings is about 5%.

Power companies typically have, for example, a commercial rate plan where each day they publish the power prices for each hour of the following day. An example “day ahead” plan from Georgia Power is set forth below:

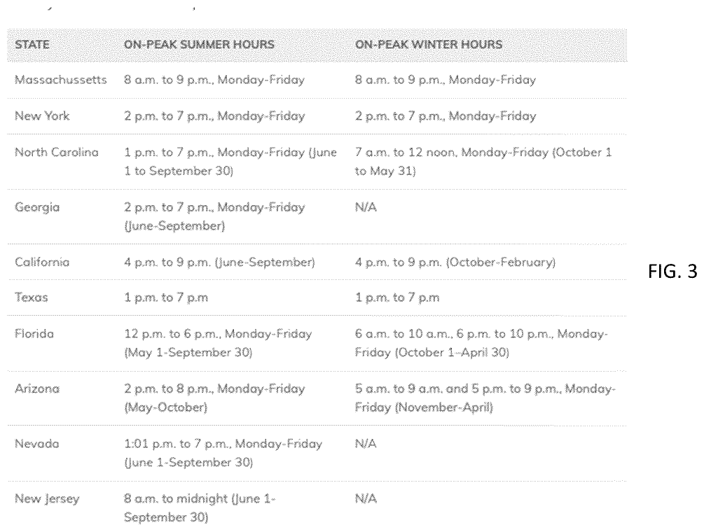

FIG. 3 shows an example tabular representation of on-peak and off-peak scheduling for various states. As can be seen, different locations can have different schedules based on a variety of factors. Some plans distinguish between weekday and weekend days.

In some pricing plans, energy prices vary over the day partly based on expected usage which was predicted using several factors, such as:
Historical daily usage-Residential power consumption generally follows the schedule noted in the previous example, but commercial power consumption often follows business hours, so the power company charges more based on the predicted load on the power grid;
Historical seasonal usage—In the southern United States more power is used in the summer for A/C during the afternoon, so the power company may charge more. This happens to coincide with the previous factor, but is distinct because it is seasonal;
Predicted transient usage—In the southern United States many homes use heat pumps for heating in the winter, but if the temperature goes below what the heat pumps can use (e.g., somewhere between 25° F. and 40° F.), electric heaters, which have a much higher energy consumption, turn on, which causes a large spike in power usage across a wide area. This typically occurs late at night or very early in the morning when the demand is generally lowest to begin with, but if a cold front arrives midday the grid can be overwhelmed.

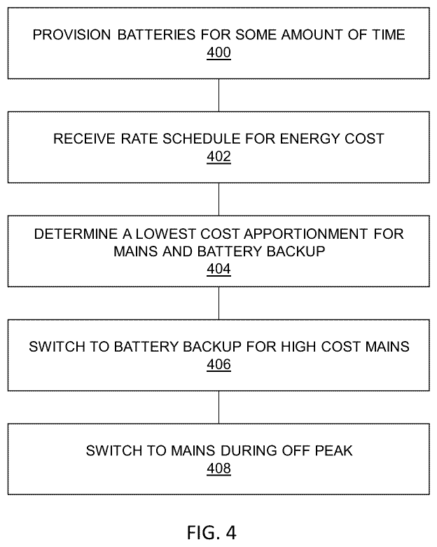

FIG. 4 shows an example sequence of steps for load-shifting of energy between mains and battery backup. In step 400, the batteries in the battery backup are provisioned to be able to supply N hours of full power usage. In some embodiments, battery backup is able to supply N hours defined by regulation plus M hours beyond the N hours required by regulatory agencies. In step 402, an on-peak/off-peak schedule from a local provider on the electrical grid is received. In step 404, an energy controller determines a lowest or low-cost apportionment between mains and battery backup based on the on-peak/off-peak schedule. In step 406, in an example embodiment, the energy controller switches to battery power (goes off the mains power supply) for the N most expensive hours each day. In step 408, the energy controller selects mains power during off peak hours and recharges battery backup during the (24-N) less expensive hours.

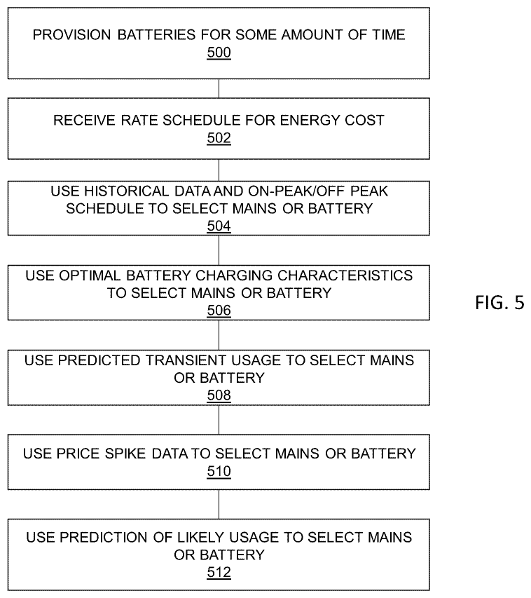

FIG. 5 shows another example sequence of steps for load-shifting of energy between mains and battery backup. In step 500, an energy controller for the communication network provisions battery backup for a number of hours of system operation. In step 502, an on-peak/off-peak energy cost schedule from a local provider on the electrical grid is received. In step 504, the energy controller uses historical data of actual daily power usage cycles and the received energy hourly rate information to determine a lowest or low-cost apportionment between mains and battery backup. In optional step 506, the energy controller additionally uses knowledge of optimal battery charging rates as a factor in determining a lowest or low cost apportionment between using mains and battery backup. In optional step 508, the energy controller additionally uses predicted transient usage in determining a lowest or acceptably low cost apportionment between using mains and battery backup. In optional step 510, the energy controller additionally takes into account multiple price spikes over a day by recharging battery backup in price dips. In optional step 512, the energy controller uses a prediction of likely usage to predict how long the batteries will last.

Example embodiments of the disclosure provide method and apparatus for power load sharing between mains and battery backup for a cellular communication system that provide advantages over known systems. A network system having access to any form of TOU power plan and a properly sized battery backup can control power consumption by switching from the mains to the battery backup when the mains power cost is high. Batteries can be sized to handle the regulator-mandated operation time for unintended power outages plus the amount of time the cell site might be intentionally using the batteries rather than the mains. In some embodiments, dynamic switching may be used to balance a number of factors in more complex TOU plans.

In some embodiments, one or more battery characteristics can be taken into account to determine optimal mains and battery load sharing. For example, charging batteries quickly may cost more than charging them slowly both in CapEx and OpEx. If after using the batteries during an expensive time they won't be needed for longer than it will take to recharge them, the batteries can be charged at a lower rate which may extend the life of the batteries. In general, the faster the batteries can be charged, the larger, and thus more expensive, the power supply. But there may be situations where it is more cost effective to quickly recharge while the mains prices are low. In embodiments, this comes down to recharger and battery technology and the characteristics of the pricing schedule.

FIGS. 4 and 5 are flow diagrams showing illustrative processing that can be implemented within the system of FIGS. 1 and 2. Rectangular elements can be considered “processing blocks” that represent computer software instructions or groups of instructions. Alternatively, the processing blocks may represent functions performed by functionally equivalent circuits such as a digital signal processor circuit or an application specific integrated circuit (ASIC). The flow diagram does not depict the syntax of any particular programming language. Rather, the flow diagram illustrates the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated, the particular sequence of blocks described is illustrative only and can be varied without departing from the spirit of the concepts, structures, and techniques described. Thus, unless otherwise stated the blocks described below are unordered meaning that, when possible, the functions represented by the blocks can be performed in any convenient or desirable order.

In another aspect, a cellular network system includes energy load shifting between multiple energy sources comprising mains, battery backup, and one or more alternative energy sources, such as wind, solar, hydroelectric, for example. The system can include an energy controller that can select one or more sources to energize the network system based on various factors, such as cost optimization, on/off peak grid pricing, battery recharging characteristics, for example. It is understood that any suitable battery type can be used. In some embodiments, gravity batteries may be used.

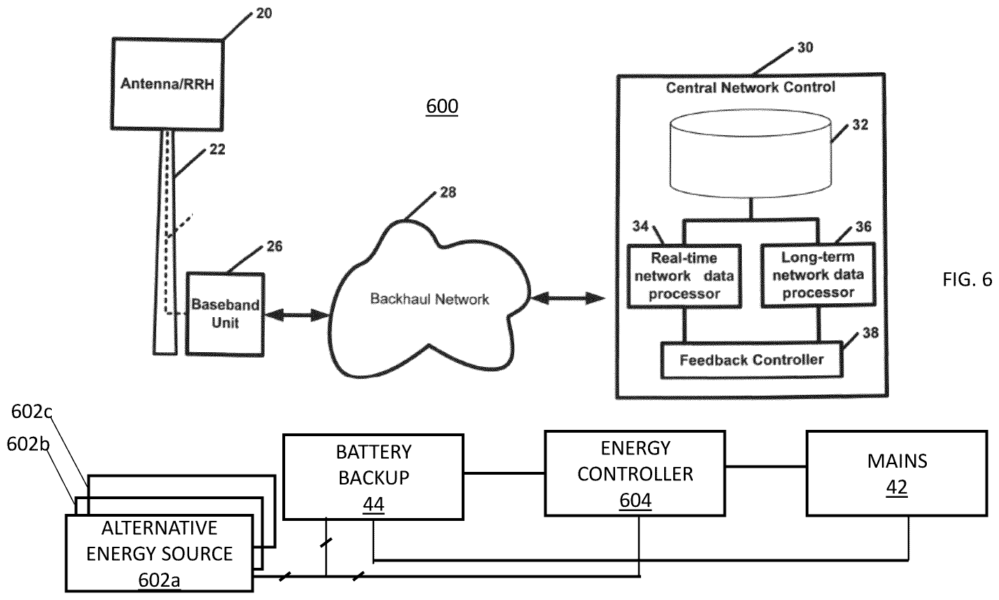

FIG. 6 shows an example communication system 600 having some commonality with the system of FIG. 2 with the addition of one or more alternative energy sources 602a-c coupled to and controlled by an energy controller 604. In embodiments, each of the alternative energy sources 602 may have one or more characteristics that can be taken into account to determine the source to provide energy to the system.

In some embodiments, one or more of the alternative energy sources 602 has an associated battery to store energy. For example, a first alternative energy source 602a comprises a solar energy system with an associated battery. Similarly, a second alternative energy source 602b can comprise a wind energy system with an associated battery. In the illustrated embodiment, each of the alternative energy sources 602a-c provides collected energy to the battery backup 44 under direction of the energy controller 604.

In embodiments, output from the alternative energy sources 602 should be conditioned before being used by the system. Signal conditioning can be performed as part of the battery backup 44 system. In some embodiments, a solar power system, e.g., 602a, attached to the power grid may not require local energy storage, i.e., no battery.

For some alternative energy sources, such as wind power 602b, the energy source may be able to run stand-alone, i.e., never drawing power from the power grid. Generally, such a system will need a battery unless the source, e.g., wind, is extremely reliable. Other alternative energy sources 602c, such as hydroelectric power, tend to be more reliable than wind, but may decrease output, or stop completely, if water flow seasonally dries up, for example. In such a case, a battery may be insufficient.

In an example embodiment, mains 42 or battery backup 44 directly, under the control of the energy controller 604, provides power for the system. Mains 42 and/or the alternative energy sources 602 charge the battery backup 44. In other embodiments, power for the system may be provided directly by an alternative energy source, such as solar power system 602a, under the control of the energy controller 604.

In some systems, the load, i.e., the system, is attached to the battery backup 44. When the battery is not fully charged, power from the mains 42 and/or alternative power sources 602 can be used to charge the battery 44. Any excess energy can be directly sent to the load. When the battery 44 is fully charged, all of the power can go to the load. In either case, the load, e.g., the system, is attached to the battery 44.

In some embodiments, the battery backup 44 can recharge and discharge at the same time, such as when the battery backup is receiving charge from an alternative energy source, such as solar energy 602a. If the instantaneous power consumption of the load is greater than the power generation of the solar cells, for example, the ‘extra’ power will come from the battery until the instantaneous consumption decreases or the power generated by the solar cells increases, then the power generated by the solar cells can be used to (re) charge the battery and supply power to the load.

Consider an example embodiment of a system in Scandinavia. It is dark for much of the day from fall through spring, and conversely, it is light for much of the day from spring through fall. This is not ideal for stand-alone solar systems. However, wind power may be desirable during times of consistent wind if the local mains power is nonexistent, is unreliable, or is expensive. If mains is nonexistent, the battery will need to be sized to handle the maximum predicted non-windy time, which could be days or even weeks. If the non-windy times reliably occur in the summer when there is lots of solar power, it might make sense to have both wind and solar, and a battery system for nights during the summer.

If there is mains power that is unreliable, battery sizing may be challenging since it may be unknown how often the power goes out and for how long, or how outages may align with windy and/or sunny periods.

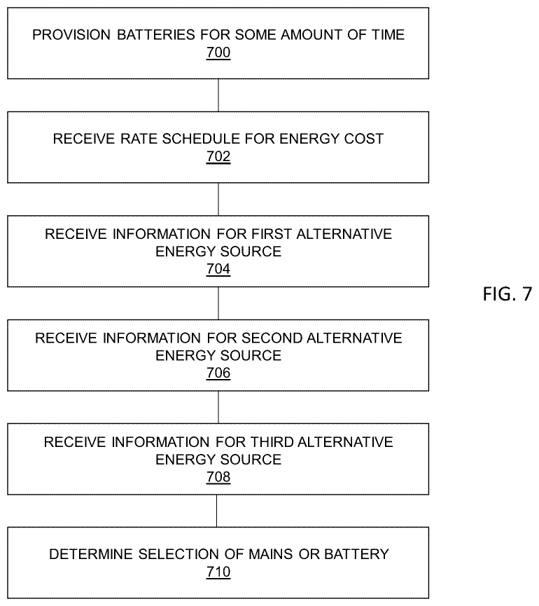

FIG. 7 shows an example sequence of steps to select an energy source for a network communication system. In step 700, battery backup is provisioned for some amount of time. In step 702, mains cost and schedule information is received. In step 704, information for a first alternative energy source, such as solar, is received. In step 706, information for a second alternative energy source, such as wind, is received. In step 708, information for a third alternative energy source, such as hydroelectric, is received. In step 710, an energy controller determines when mains and when battery backup powers the system. In an alternative embodiment, the energy controller can select one of the alternative energy sources to power the system.

It is understood that a wide range of information can be used to select a source to power the system. For example, a solar system may provide energy during the day but not at night. Weather information, such as the actual or predicted level of cloudiness or precipitation, can be used select mains or battery. For example, based on a predicted sunny day tomorrow, and high cost of energy from the grid, the energy controller may let the battery charge level get relatively low since solar power will soon begin providing charge to the battery. Similarly, predicted wind speed and duration may be used to estimate how much charge will be supplied to battery over some period of time. Based on that estimate, the energy controller may select battery. For example, during times of relatively constant strong winds, even at night, it may be possible to power the system from battery for relatively long periods of time since the battery may receive wind energy while providing power to the system.

In some embodiments, some factors may be weighed more heavily than others when processing information for the mains, battery, and alternative energy sources. For example, configuring the system to send energy back to the grid may be most heavily weighted. In other embodiments, system operation can be configured to maximize battery life or other high-cost system components. In some embodiments, power companies pay a lot more for alternative energy sources in order to keep the power grid operating. In those situations, generated power, e.g., from solar cells, is diverted to the grid rather than topping up the batteries.

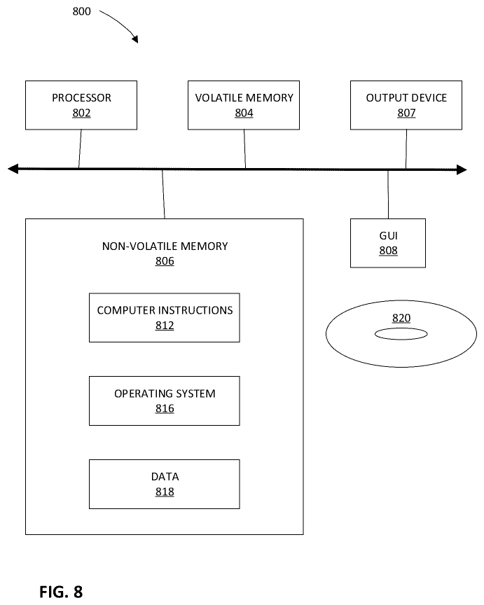

FIG. 8 shows an exemplary computer 800 that can perform at least part of the processing described herein. For example, the computer 800 can perform processing to receive energy source information and process the information to select mains or battery. The computer 800 includes a processor 802, a volatile memory 804, a non-volatile memory 806 (e.g., hard disk), an output device 807 and an optional graphical user interface (GUI) 808 (e.g., a mouse, a keyboard, a display, for example). The non-volatile memory 806 stores computer instructions 812, an operating system 816 and data 818. In one example, the computer instructions 812 are executed by the processor 802 out of volatile memory 804. In one embodiment, an article 820 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

Although reference is made herein to particular systems or configurations, it is appreciated that other systems or configurations having similar functional and/or structural properties may be substituted where appropriate, and that a person having ordinary skill in the art would understand how to select such systems or configurations and incorporate them into embodiments which incorporate the concepts, techniques, and structures set forth herein without deviating from the scope of those teachings.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Unless otherwise defined, the terms “approximately” and “about” mean within ±20% of a target value in some embodiments. The terms “approximately” and “about” may include the target value. The term “substantially equal” may be used to refer to values that are within ±20% of one another in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A cellular network system, comprising:
an energy controller having a processor and memory configured to:
provision a battery backup to supply power to the system for X number of hours;
process information for at least one alternative energy source; and
load shift power to the system between mains power and the battery backup based on one or more characteristics of the mains power, the battery backup, and/or the at least one alternative energy source.

2. The system according to claim 1, wherein the one or more characteristics of the mains power includes a cost schedule having on-peak and off-peak rates.

3. The system according to claim 1, wherein the at least one alternative energy source comprises a solar system and/or wind power system.

4. The system according to claim 3, wherein the at least one alternative energy source provides energy to the battery backup.

5. The system according to claim 1, wherein the processor and the memory are configured to load shift power to the system based on one or more characteristics of batteries in the battery backup.

6. The system according to claim 5, wherein the one or more characteristics of batteries in the battery backup include battery charge/discharge characteristics.
